(19) United States
(12) Patent Application Publication
(10) Pub. No.: US 2026/0287329 A1
(43) Pub. Date: Sep. 24, 2026

(54) MEASUREMENT PROCESSING APPARATUS, MEASUREMENT METHOD, AND STORAGE MEDIUM

(71) Applicant: Otsuka Electronics Co., Ltd., Osaka (JP)

(72) Inventors: Sota OKAMOTO, Osaka (JP); Koichi MORIMOTO, Osaka (JP); Yoshimi SAWAMURA, Osaka (JP); Takao WADA, Osaka (JP)

(73) Assignee: Otsuka Electronics Co., Ltd., Osaka (JP)

(21) Appl. No.: 19/573,612

(22) Filed: Mar. 20, 2026

(30) Foreign Application Priority Data
Mar. 24, 2025 (JP) 2025-048586

(51) Int. Cl. G01B 11/06

(52) U.S. Cl. CPC G01B 11/0625

(57) ABSTRACT

A measurement processing apparatus obtains a spectrum of observed light produced from a sample as the sample is irradiated with measurement light, extracts, as a candidate group, one or more data sets each including a spectrum similar to the spectrum of the observed light, with regard to each of the one or more data sets in the candidate group, fits parameters of a model formula determined based on the film model in the data set so that a spectrum calculated based on the model formula matches the spectrum of the observed light, and determines a film thickness of each layer of the sample based on one or more of measurement results calculated for the data sets in the candidate group.

### CROSS REFERENCE TO RELATED APPLICATIONS

This nonprovisional application is based on Japanese Patent Application No. 2025-048586 filed on Mar. 24, 2025 with the Japan Patent Office, the entire contents of which are hereby incorporated by reference.

### BACKGROUND OF THE INVENTION

### Field of the Invention

The present disclosure relates to a measurement processing apparatus, a measurement method, and a storage medium for measuring a film thickness of a sample or the like.

### Description of the Background Art

A known optical interference type measuring apparatus is used to measure the film thickness and optical constant of a thin film (for example, see Japanese Patent Laying-Open No. 2000-065536).

In order to measure a film thickness of a sample in an optical interference type measurement apparatus, it is necessary to fit a reflectance spectrum or a transmittance spectrum obtained from the sample to a spectrum theoretically calculated according to a model formula prepared in advance (see, for example, Japanese Patent Application Laid-Open No. 2013-040813).

### SUMMARY OF THE INVENTION

Although it is necessary to prepare a model formula according to the sample, it is difficult for a user with little expert knowledge to prepare the model formula.

According to an embodiment, a measurement processing apparatus performs operations that include: obtaining a spectrum of observed light produced from a sample as the sample is irradiated with measurement light; extracting, as a candidate group, one or more data sets each including a spectrum similar to the spectrum of the observed light with reference to a database including one or more data sets each including at least a film model, an analysis condition, and a spectrum; with regard to each of the one or more data sets in the candidate group, fitting parameters of a model formula determined based on the film model in the data set in accordance with the analysis condition in the data set so that a spectrum calculated based on the model formula matches the spectrum of the observed light, thereby calculating a measurement result including a film thickness of each layer of the sample; and determining a film thickness of each layer of the sample based on one or more of measurement results calculated for the data sets in the candidate group.

The operations may include calculating one or more indicator values based on a result of comparing the spectrum of the observed light with a theoretical spectrum calculated by applying the measurement result to the model formula. The film thickness of each layer of the sample may be determined based on the one or more indicator values for each measurement result.

The process of fitting parameters of the model formula may include varying a film thickness of each layer and at least partially varying an optical constant of each layer.

A first measurement result may be calculated by fitting parameters of the model formula under a condition that a film thickness of each layer is allowed to vary while an optical constant of each layer is fixed. A second measurement result may be calculated by fitting parameters of the model formula under a condition that a film thickness of each layer is allowed to vary at least partially and an optical constant of each layer is allowed to vary at least partially, using the first measurement result as a reference. The operations may further include discarding the second measurement result when a variation in the second measurement result exceeds a predetermined threshold.

At least a part of the database may be located in a server separate from the measurement processing apparatus.

The operations may include producing a data set based on the determined film thickness of each layer of the sample and adding the data set to the database.

The film model in the data set may include a default value of an optical constant of each layer. The analysis condition may include specifying an analysis method for fitting parameters of the model formula.

According to an embodiment, a measurement method includes: obtaining a spectrum of observed light produced from a sample as the sample is irradiated with measurement light; extracting, as a candidate group, one or more data sets each including a spectrum similar to the spectrum of the observed light with reference to a database including one or more data sets each including at least a film model, an analysis condition, and a spectrum; with regard to each of the one or more data sets in the candidate group, fitting parameters of a model formula determined based on the film model in the data set in accordance with the analysis condition in the data set so that a spectrum calculated based on the model formula matches the spectrum of the observed light, thereby calculating a measurement result including a film thickness of each layer of the sample; and determining a film thickness of each layer of the sample based on one or more of measurement results calculated for the data sets in the candidate group.

According to an embodiment, a storage medium storing instructions is provided. The instructions cause, when executed by one or more processors, the one or more processors to perform operations that include: obtaining a spectrum of observed light produced from a sample as the sample is irradiated with measurement light; extracting, as a candidate group, one or more data sets each including a spectrum similar to the spectrum of the observed light with reference to a database including one or more data sets each including at least a film model, an analysis condition, and a spectrum; with regard to each of the one or more data sets in the candidate group, fitting parameters of a model formula determined based on the film model in the data set in accordance with the analysis condition in the data set so that a spectrum calculated based on the model formula matches the spectrum of the observed light, thereby calculating a measurement result including a film thickness of each layer of the sample; and determining a film thickness of each layer of the sample based on one or more of measurement results calculated for the data sets in the candidate group.

The foregoing and other objects, features, aspects, and advantages of the present disclosure will become apparent from the following detailed description of the present disclosure when taken in conjunction with the accompanying drawings.

### BRIEF DESCRIPTION OF THE DRAWINGS

FIG. 1 is a schematic diagram illustrating an example of a configuration of an optical measurement system according to an embodiment.

FIG. 2 is a schematic diagram illustrating an example of a cross-sectional structure of a spectroscopic detector included in the optical measurement system according to the present embodiment.

FIG. 3 is a schematic diagram illustrating an example of a configuration of a measurement processing apparatus included in the optical measurement system according to the present embodiment.

FIG. 4 is a diagram illustrating an example of a measurement knowledge database included in a database of the optical measurement system according to the present embodiment.

FIGS. 5A to 5C are schematic diagrams each illustrating an example of a sample structure indicated by a film model indicated in FIG. 4.

FIG. 6 is a diagram illustrating an example of a material information database included in the database of the optical measurement system according to the present embodiment.

FIG. 7 is a flowchart of an example of a measurement process of the optical measurement system according to the present embodiment.

FIG. 8 is a diagram for illustrating an example of the measurement process of the optical measurement system according to the present embodiment.

FIG. 9 is a schematic diagram illustrating an example of operating the measurement processing apparatus according to the present embodiment.

### DESCRIPTION OF THE PREFERRED EMBODIMENTS

Embodiments of the present disclosure will now be described in detail with reference to the drawings. In the figures, identical or equivalent components are identically denoted and will not be described repeatedly.

### A. Optical Measurement System

Initially, an example of a configuration of an optical measurement system 1 according to an embodiment will be described.

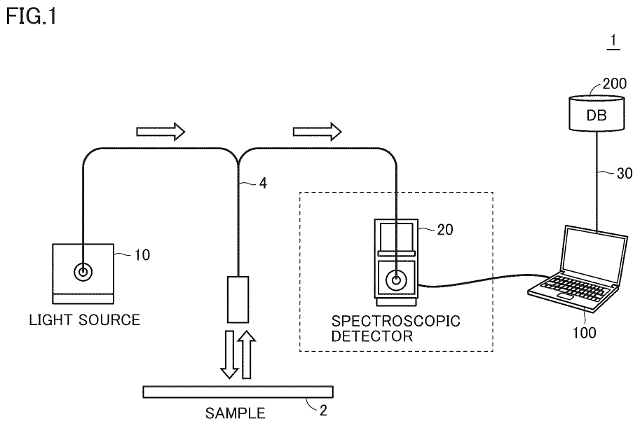

Referring to FIG. 1, optical measurement system 1 comprises a light source 10 that generates measurement light for irradiating a sample 2, a spectroscopic detector 20 that receives observed light (for example, reflected light or transmitted light) produced from sample 2 by irradiation with the measurement light, and a measurement processing apparatus 100 that receives a detection result of spectroscopic detector 20. The detection result indicates optical intensity for each wavelength.

Optical measurement system 1 irradiates sample 2 with the measurement light output from light source 10 to observe optical interference caused inside sample 2 to measure one or more films included in sample 2 in thickness or the like. Sample 2 for example has a substrate and one or more films formed on the substrate.

While FIG. 1 shows, as an example, a reflective optical system that irradiates sample 2 with measurement light and observes reflected light caused at sample 2, a transmissive optical system that irradiates sample 2 with measurement light and observes transmitted light transmitted through sample 2 may be employed.

Measurement processing apparatus 100 measures a film thickness or optical constant (refractive index or extinction coefficient) of sample 2 based on the detection result of spectroscopic detector 20. Measurement processing apparatus 100 refers to a database 200 to perform a measurement process described hereinafter. At least a part of database 200 may be located in a server separate from measurement processing apparatus 100. In that case, measurement processing apparatus 100 may access database 200 via a network 30. Database 200 may be part of measurement processing apparatus 100.

Light source 10 and spectroscopic detector 20 are optically interconnected via a Y-type fiber 4 having an illumination port directed toward sample 2.

Light source 10 generates measurement light having a predetermined wavelength range. The wavelength range of the measurement light is determined according to a film thickness measurement range or the like. Light source 10 is for example a halogen lamp, a white LED, or the like.

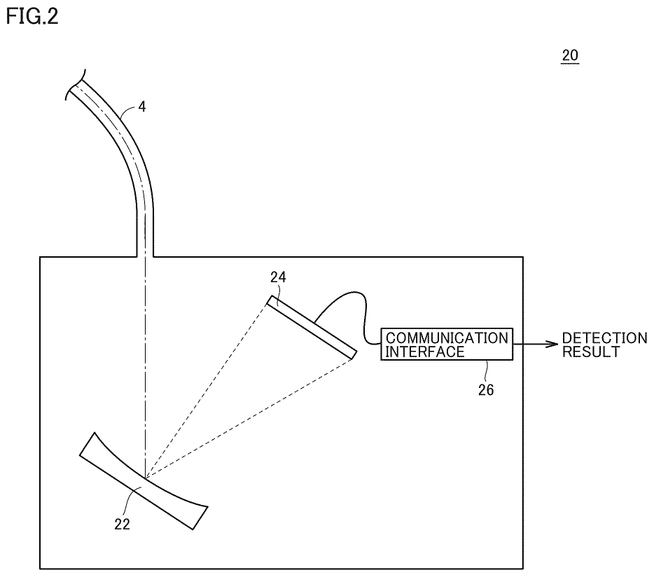

Referring to FIG. 2, spectroscopic detector 20 includes a diffraction grating 22 that diffracts light incident through Y-type fiber 4, a light receiving unit 24 disposed in association with diffraction grating 22, and a communication interface 26 that is electrically connected to light receiving unit 24 for outputting a detection result to measurement processing apparatus 100. Light receiving unit 24 includes a line sensor, a two-dimensional sensor, or the like, and can output intensity for each wavelength component as a detection result.

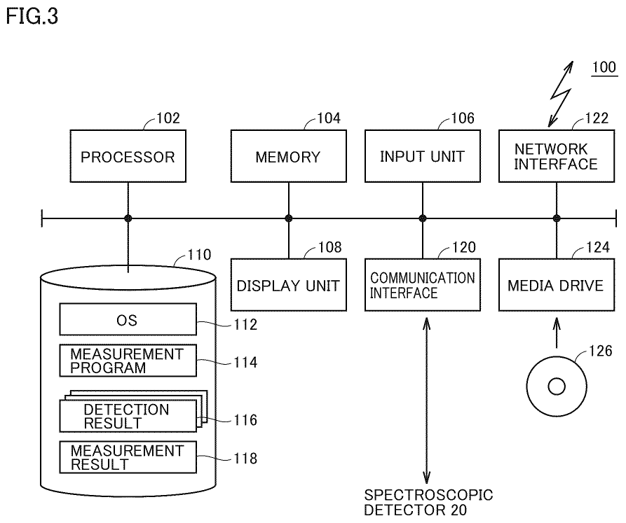

Referring to FIG. 3, measurement processing apparatus 100 comprises a processor 102, a memory 104, an input unit 106, a display unit 108, a storage 110, a communication interface 120, a network interface 122, and a media drive 124.

Processor 102 is typically a processing unit such as a central processing unit (CPU) or a graphics processing unit (GPU), and reads into memory 104 one or more programs stored in storage 110 and executes the one or more read programs. Memory 104 is a volatile memory such as dynamic random access memory (DRAM) or static random access memory (SRAM), and functions as a working memory for processor 102 to execute a program.

Input unit 106 includes a keyboard, a mouse, and the like, and receives an operation from a user. Display unit 108 outputs to the user a result of the execution of the program by processor 102.

Storage 110 includes a hard disk, a flash memory or a similar nonvolatile memory, and stores a variety of types of programs and data. More specifically, storage 110 holds an operating system (OS) 112, a measurement program 114, a detection result 116, and a measurement result 118.

Operating system 112 provides an environment in which processor 102 executes a program. Measurement program 114 is executed by processor 102 to implement an optical measurement method or the like according to the present embodiment. Detection result 116 includes data output from spectroscopic detector 20. Measurement result 118 includes a calculated value of an optical property, such as a film thickness, obtained by executing measurement program 114.

Communication interface 120 mediates data transmission between measurement processing apparatus 100 and spectroscopic detector 20. Network interface 122 mediates data transmission between measurement processing apparatus 100 and an external server.

Media drive 124 reads necessary data from a storage medium 126 (for example, an optical disk or the like) storing a program to be executed by processor 102, and stores the data in storage 110. Measurement program 114 or the like executed in measurement processing apparatus 100 may be installed via storage medium 126 or the like, or may be downloaded from the server via network interface 122 or the like.

Measurement program 114 may invoke a necessary one of program modules that are provided as a part of operating system 112 in a predetermined arrangement at a predetermined timing to execute processing. Even when the module is not included, measurement program 114 is encompassed in the scope of the present disclosure. Measurement program 114 may be incorporated in a part of another program and thus provided.

A function provided by processor 102 of measurement processing apparatus 100 executing measurement program 114 may be implemented entirely or partially by dedicated hardware.

### B. Overview of Measurement Process

Hereinafter, a measurement process performed by measurement processing apparatus 100 for film thickness measurement according to the present embodiment will be described.

Measurement processing apparatus 100 observes optical interference occurring inside sample 2 to measure one or more films included in sample 2 in thickness or the like. More specifically, measurement processing apparatus 100 obtains a reflectance spectrum or transmittance spectrum of sample 2 (hereinafter also simply referred to as a “spectrum”) based on the detection result of spectroscopic detector 20. Note that measurement processing apparatus 100 obtains a reference in advance for calculating a spectrum.

The film thickness of the sample is determined by fitting parameters of a model formula of the sample so that a spectrum calculated based on the model formula matches the obtained spectrum. Together with the film thickness, an optical constant may be determined. The spectrum calculated based on the model formula of the sample may be compared with the obtained spectrum as they are, or the spectra may be subjected to frequency conversion to provide power spectra which may in turn be compared with each other. The calculation of the spectrum based on the model formula may use a simulation based on the model formula.

Fitting of parameters of the model formula may use a least squares method aimed at minimizing a least squares error indicating an error between the spectra or between the power spectra. Alternatively, an optimization method such as a maximum entropy method (MEM) may be used to determine parameters of the model formula such that an error is minimized.

### C. Database 200

Hereinafter, database 200 of optical measurement system 1 according to the present embodiment will be described.

Measurement processing apparatus 100 determines a model formula or the like with reference to database 200 and performs a measurement process.

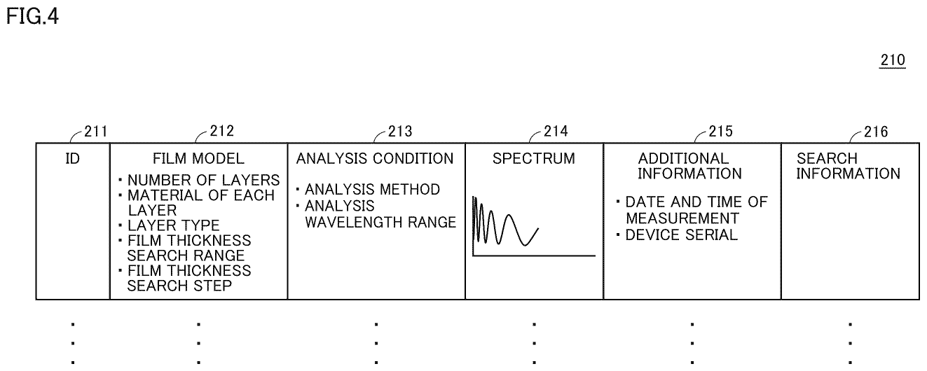

Referring to FIG. 4, a measurement knowledge database 210 includes one or more knowledge data sets. Each knowledge data set for example includes an ID 211, a film model 212, an analysis condition 213, a spectrum 214, additional information 215, and search information 216.

ID 211 is information for identifying a knowledge data set. Film model 212 includes information indicative of a sample structure. Film model 212 for example includes information such as the number of layers included in a sample, the material(s) of each layer, the layer type of each layer, a film thickness search range for each layer, and a film thickness search step for each layer. As the layer type, for example, information is set such as a single layer indicating a layer formed of a single material, a non-interference layer indicating a layer in which no optical interference is observed, etc. In film model 212, the film thickness of each layer may not be set.

The film thickness search range for each layer and the film thickness search step for each layer indicate a range and an amount, respectively, of variation in film thickness of each layer in fitting parameters of a model formula.

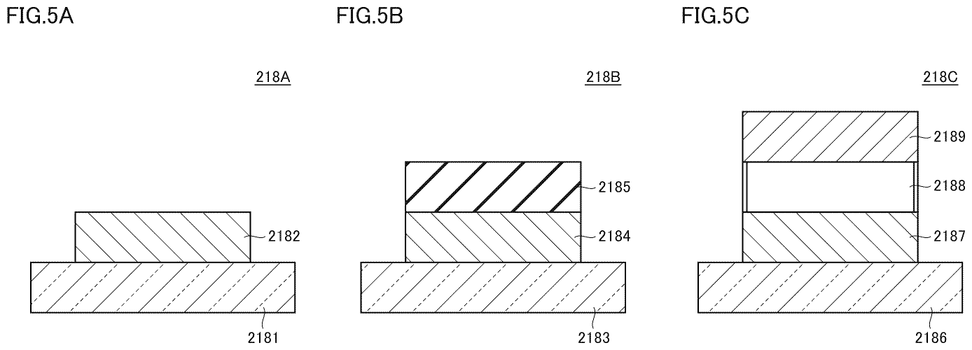

Referring to FIG. 5A, a sample structure 218A has a substrate 2181 and a first layer 2182 formed thereon. For example, substrate 2181 is set as a non-interference layer and first layer 2182 is set as a single layer. When the measurement light is incident on sample structure 218A from an upper side of the figure, reflection occurs at a surface of first layer 2182 and an interface between first layer 2182 and substrate 2181.

Referring to FIG. 5B, a sample structure 218B has a substrate 2183 and a first layer 2184 and a second layer 2185 formed on the substrate. For example, substrate 2183 is set as a non-interference layer, and first layer 2184 and second layer 2185 are each set as a single layer. When the measurement light is incident on sample structure 218B from an upper side of the figure, reflection occurs at a surface of second layer 2185, an interface between second layer 2185 and first layer 2184, and an interface between first layer 2184 and substrate 2183.

Referring to FIG. 5C, a sample structure 218C has a substrate 2186 and a first layer 2187 formed thereon. First layer 2187 has a second layer 2189 formed with an air layer 2188 posed therebetween. For example, substrate 2186 and air layer 2188 are both set as non-interference layers, and first layer 2187 and second layer 2189 are both set as a single layer. When the measurement light is incident on sample structure 218C from an upper side of the figure, reflection occurs at a surface of second layer 2189, an interface between second layer 2189 and air layer 2188, an interface between air layer 2188 and first layer 2187, and an interface between first layer 2187 and substrate 2186. Note that air layer 2188 has a refractive index smaller than those of first layer 2187 and second layer 2189.

Referring to FIG. 4 again, analysis condition 213 for example includes information such as an analysis method, an analysis wavelength range etc. used to calculate film thickness. Analysis condition 213 includes specifying an analysis method for fitting parameters of a model formula. As the analysis method, for example, a least squares method, an optimization method, or the like is specified.

Spectrum 214 is a spectrum measured from sample 2 of interest. Spectrum 214 represents sample 2 in reflectance or transmittance for each wavelength.

Additional information 215 for example includes date and time at which a spectrum corresponding thereto is measured, a device serial (for example, a serial number of spectroscopic detector 20), and the like. Based on additional information 215, only a knowledge data set obtained with a specific device used may be filtered. Additional information 215 may include a confidence level of a measurement result that produces a knowledge data set.

Search information 216 is information for searching through measurement knowledge database 210 for a knowledge data set of interest. For example, search information 216 may include information for enabling filtering under conditions such as a sample having a film deposited on a glass substrate, a sample having a film deposited on a silicon substrate, and a sample including an air layer.

Database 200 may include a database of materials included in film model 212.

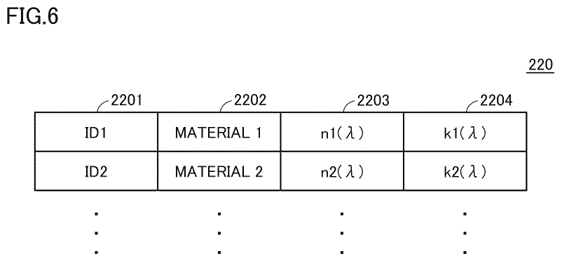

Referring to FIG. 6, a material information database 220 includes one or more pieces of material information. Each piece of material information included in material information database 220 for example includes an ID 2201, a material name 2202, a refractive index 2203, and an extinction coefficient 2204.

ID 2201 is information for identifying material information.

Material name 2202 is a name of a material indicated by the material information, and may be set as desired.

Refractive index 2203 and extinction coefficient 2204 are default values of an optical constant of the material of interest. As refractive index 2203 is set a refractive index n(λ) of the material of interest. As extinction coefficient 2204 is set an extinction coefficient k(λ) of the material of interest. The refractive index n(λ) and the extinction coefficient k(λ) may both reflect wavelength dependence or wavelength dispersion. The refractive index n(λ) and the extinction coefficient k(λ) may define a value for each wavelength or may be defined using a predetermined function.

For example, if a material can be regarded as having an extinction coefficient k(λ)≈0, Cauchy's dispersion formula may be used to define the refractive index n(λ). In that case, a coefficient defining Cauchy's dispersion formula may be set as refractive index 2203. Alternatively, a function including the Tauc-Lorentz oscillator may be used.

Film model 212 included in each knowledge data set is associated with material information database 220 to have a default value set for the optical constant of each layer.

### D. Measurement Process

Hereinafter, an example of a measurement process performed by measurement processing apparatus 100 of optical measurement system 1 according to the present embodiment will be described.

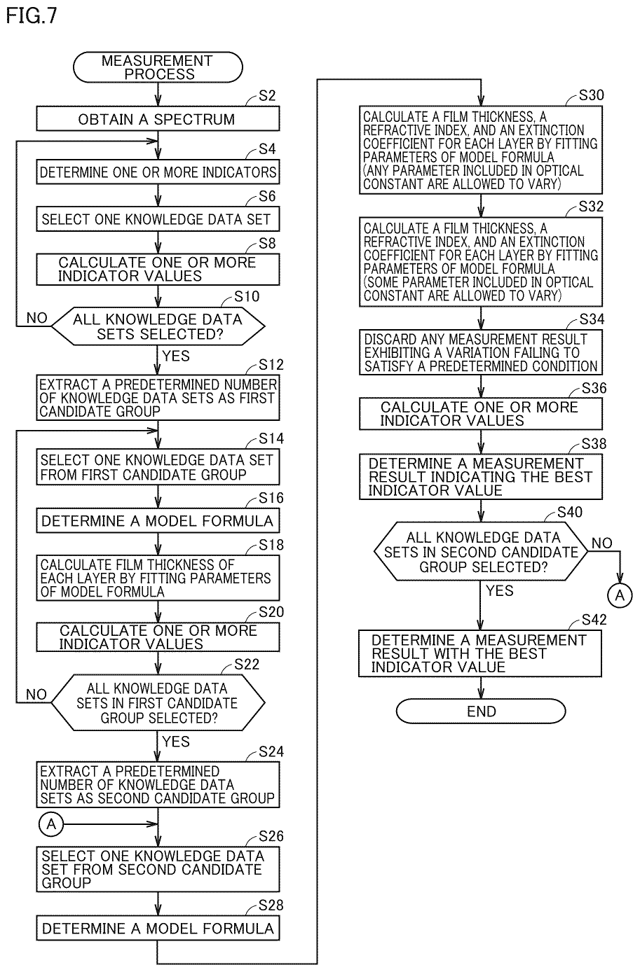

An example of a measurement process of optical measurement system 1 according to the present embodiment will be described with reference to FIG. 7. The process performed by measurement processing apparatus 100 as indicated in FIG. 7 may be implemented for example by processor 102 of measurement processing apparatus 100 executing measurement program 114.

Measurement processing apparatus 100 radiates measurement light to obtain a spectrum of observed light produced from sample 2. As one example, measurement processing apparatus 100 obtains a spectrum of sample 2 as detected by spectroscopic detector 20 (step S2). The spectrum may be a reflectance spectrum or a transmittance spectrum.

Measurement processing apparatus 100 determines one or more indicators for extracting a knowledge data set from measurement knowledge database 210 included in database 200 (step S4).

Measurement processing apparatus 100 selects one knowledge data set included in measurement knowledge database 210 (step S6), compares the spectrum obtained in step S2 with spectrum 214 included in the selected knowledge data set, and calculates one or more indicator values (step S8). Measurement processing apparatus 100 calculates an indicator value for each of the one or more indicators determined in step S4.

The one or more indicator values calculated in step S8 indicate similarity between the spectrum obtained in step S2 and spectrum 214 included in the selected knowledge data set. For example, a residual, a correlation coefficient, or the like may be adopted as an indicator indicating the similarity. An indicator that expands the residual or the correlation coefficient while the number of data of the spectrum is considered may be employed.

Steps S6 and S8 are repeated until all the knowledge data sets included in measurement knowledge database 210 have been selected (YES in step S10).

Measurement processing apparatus 100 extracts a predetermined number of knowledge data sets as a first candidate group in an order in which the knowledge data sets have the one or more indicator values calculated in step S8 better (step S12). Measurement processing apparatus 100 may rank the knowledge data sets extracted as the first candidate group such that a knowledge data set having the one or more indicator values calculated in step S8 better has a higher rank.

For example, 100 knowledge data sets may be extracted as the first candidate group. The number of knowledge data sets extracted as the first candidate group may be set or modified as desired.

When a plurality of indicator values are calculated in step S8, the first candidate group may be extracted in step S12 based on a combination of the plurality of indicator values.

Step S8 may be performed using a neural network or the like. In that case, step S4 of determining an indicator may be dispensed with.

Steps S4 to S12 correspond to a process of extracting from measurement knowledge database 210 the first candidate group of knowledge data sets used for measurement. That is, measurement processing apparatus 100 extracts, as a candidate group, one or more knowledge data sets each including a spectrum similar to that of the observed light with reference to measurement knowledge database 210 including one or more knowledge data sets each including at least film model 212, analysis condition 213, and spectrum 214.

Subsequently, measurement processing apparatus 100 selects one knowledge data set from the knowledge data sets extracted as the first candidate group (step S14), and determines a model formula based on film model 212 included in the selected knowledge data set (step S16). The determined model formula is a theoretical formula reflecting a sample structure indicated by film model 212 as shown in FIGS. 5A-5C. In the determined model formula, for an optical constant, a default value predetermined in material information database 220 (see FIG. 6) may be used.

Measurement processing apparatus 100 fits parameters of the model formula in accordance with analysis condition 213 included in the selected knowledge data set so that a spectrum calculated based on the model formula matches the spectrum obtained in step S2, thereby calculating film thickness of each layer (step S18). A measurement result of step S18 includes a calculated film thickness of each layer and a default value of the optical constant of each layer.

As a spectrum analysis method, an optimization method, a least squares method, or the like defined in analysis condition 213 is adopted. In step S18, an optimal film thickness is searched for by sequentially varying the film thickness of each layer defined in film model 212. That is, fitting of parameters of a model formula includes varying the film thickness of each layer.

Measurement processing apparatus 100 calculates one or more indicator values based on a result of comparing the spectrum obtained in step S2 with a theoretical spectrum calculated by applying a retrieved film thickness to film model 212 (step S20). That is, the one or more indicator values are calculated based on a result of comparing the spectrum of the observed light with a theoretical spectrum calculated by applying a measurement result to a model formula. The calculated one or more indicator values may be the same as or different from those in step S8.

Steps S14 to S20 are repeated until all the knowledge data sets in the first candidate group have been selected (YES in step S22).

Thus, with regard to each of one or more knowledge data sets included in a first candidate group, measurement processing apparatus 100 fits parameters of a model formula determined based on film model 212 included in the knowledge data set in accordance with analysis condition 213 included in the knowledge data set so that a spectrum calculated based on the model formula matches the spectrum of the observed light, thereby calculating a measurement result including a film thickness of each layer of sample 2.

Measurement processing apparatus 100 determines a film thickness for each layer of sample 2 based on one or more measurement results of (e.g., 100) calculated measurement results corresponding to the knowledge data sets included in the first candidate group. While the measurement result having the best indicator value may be determined as the film thickness of each layer of sample 2, a more detailed analysis may be performed using the knowledge data set(s) corresponding to the one or more measurement results as a second candidate group, as will be described hereinafter.

Specifically, measurement processing apparatus 100 extracts a predetermined number of knowledge data sets as the second candidate group based on the one or more indicator values calculated in step S20 (step S24). For example, of measurement results based on 100 knowledge data sets, 10 knowledge data sets with better indicator values and measurement results based on the knowledge data sets may be extracted. The number of knowledge data sets extracted as the second candidate group may be set or modified as desired. Only one knowledge data set may be extracted as the second candidate group.

When an indicator value is calculated for each of a plurality of indicators in step S24, a knowledge data set indicating a good indicator value and a measurement result based on the knowledge data set may be extracted for each type of indicator. In that case, the second candidate group may be a set of knowledge data sets extracted for each type of indicator.

Steps S14 to S24 correspond to a process of performing measurement based on the first candidate group of knowledge data sets and extracting a promising knowledge data set of the candidate knowledge data sets as the second candidate group.

Subsequently, a searching step is performed with an optical constant (a refractive index or an extinction coefficient) varied. That is, the searching step is performed with a film thickness and, in addition, an optical constant also varied. The searching step may be performed for a case in which any parameters in the optical constant are varied and a case in which some parameters in the optical constant are varied. Which parameters in the optical constant are to be allowed to vary may be determined based on additional information included in a knowledge data set corresponding thereto.

Specifically, measurement processing apparatus 100 selects one knowledge data set from the knowledge data sets extracted as the second candidate group (step S26), and determines a model formula based on film model 212 included in the selected knowledge data set (step S28). Step S28 is substantially the same as step S16, and accordingly, may be skipped and the model formula determined in step S16 may be reused.

Measurement processing apparatus 100 fits the parameters of the model formula in accordance with analysis condition 213 included in the selected knowledge data set and under the condition that any parameter in the optical constant is allowed to vary so that a spectrum calculated based on the model formula matches the spectrum obtained in step S2, thereby calculating a film thickness, a refractive index, and an extinction coefficient for each layer (step S30). The measurement result of step S30 includes the calculated film thickness, refractive index, and extinction coefficient for each layer.

Measurement processing apparatus 100 fits the parameters of the model formula in accordance with analysis condition 213 included in the selected knowledge data set and under the condition that a part of the parameters in the optical constant is allowed to vary so that a spectrum calculated based on the model formula matches the spectrum obtained in step S2, thereby calculating a film thickness, a refractive index and an extinction coefficient for each layer (step S32). The measurement result of step S32 includes the calculated film thickness, refractive index, and extinction coefficient for each layer, and default values of parameters of the optical constants that are not varied.

Step S32 may be performed for each of a plurality of cases in which different ones of parameters in the optical constant are variable.

Measurement processing apparatus 100 discards any of the measurement results in step S30 and step S32 exhibiting a variation failing to satisfy a predetermined condition (step S34). For example, measurement processing apparatus 100 compares a film thickness of each layer calculated through an analysis with the optical constant fixed (the calculation result in step S18) and a default value of the optical constant (a value set in material information database 220) with the film thickness and optical constant of the layer calculated in step S30 or S32, and if any layer has a film thickness or optical constant with a variation exceeding a predetermined threshold value, the measurement processing apparatus discards the measurement result of step S30 or step S32.

Thus, measurement processing apparatus 100 calculates a measurement result (the calculation result in step S18) by fitting parameters of a model formula under the condition that the film thickness of each layer is allowed to vary while the optical constant of the layer is fixed and the measurement processing apparatus also calculates a measurement result (the calculation result in step S30 or S32) by fitting parameters of the model formula under the condition that the film thickness of each layer is allowed to vary and the optical constant of the layer is allowed to vary at least partially, and when, with reference to the measurement result obtained while the film thickness is allowed to vary while the optical constant is fixed, the measurement result obtained while the film thickness is allowed to vary while the optical constant is allowed to vary at least partially has a variation exceeding a predetermined threshold value, the measurement processing apparatus discards the latter.

The threshold value used in step S34 may be set for each of the film thickness, the refractive index, and the extinction coefficient, as desired.

Measurement processing apparatus 100 calculates one or more indicator values based on a result of comparing the spectrum obtained in step S2 with a theoretical spectrum calculated by applying the measurement results of steps S30 and S32 to the model formula (step S36). Measurement processing apparatus 100 determines a measurement result indicating the best indicator value (step S38) among the measurement result obtained when the optical constant has a default value (step S18), the measurement result obtained when any parameters in the optical constant are allowed to vary (step S30), and the measurement result obtained when some parameters in the optical constant are allowed to vary (step S32).

Steps S26 to S38 are repeated until all the knowledge data sets in the second candidate group have been selected (YES in step S40).

Measurement processing apparatus 100 determines the best one of the measurement results determined in step S38 (step S42).

The measurement result determined in step S42 may be output as a final measurement result. Thus, a film thickness for each layer of sample 2 may be determined based on one or more indicator values of each measurement result.

For the sake of description, while FIG. 7 specifically indicates necessary steps, a step which can use a previous calculation result may use the previous calculation result as much as possible to eliminate a redundant calculation to reduce a processing load. Some or all of the steps may be performed in parallel.

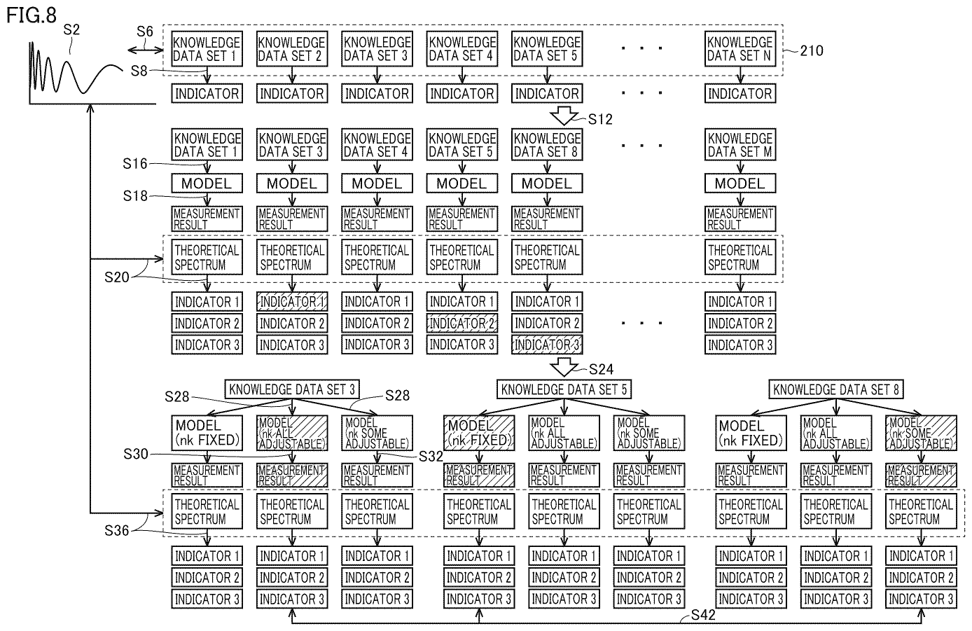

Referring to FIG. 8, for example, it is assumed that measurement knowledge database 210 including N knowledge data sets is prepared.

Once measurement processing apparatus 100 obtains a spectrum (step S2), the measurement processing apparatus compares the obtained spectrum with a spectrum included in each knowledge data set included in measurement knowledge database 210 and calculates one or more indicators for each knowledge data set based on a result of the comparison (step S8).

Measurement processing apparatus 100 extracts a predetermined number of knowledge data sets (a first candidate group of knowledge data sets) in an order in which the knowledge data sets have the calculated one or more indicator values better (step S12). FIG. 8 illustrates an example in which M knowledge data sets are extracted from N knowledge data sets, where M≤N.

Subsequently, measurement processing apparatus 100 determines a model formula for each of the M knowledge data sets based on film model 212 included in each knowledge data set (step S16). Subsequently, measurement processing apparatus 100 fits parameters of the model formula in accordance with analysis condition 213 included in each knowledge data set so that a spectrum calculated based on the model formula matches the obtained spectrum, thereby calculating a film thickness of each layer (step S18).

Further, measurement processing apparatus 100 calculates one or more indicator values based on a result of comparing the obtained spectrum with a theoretical spectrum calculated by applying a retrieved film thickness to the model formula (step S20).

Measurement processing apparatus 100 extracts a predetermined number of knowledge data sets as a second candidate group based on the calculated one or more indicator values (step S24). FIG. 8 shows an example in which three indicators are calculated. For an indicator 1, a knowledge data set 3 indicates the best indicator value. For an indicator 2, a knowledge data set 5 indicates the best indicator value. For an indicator 3, a knowledge data set 8 indicates the best indicator value.

Subsequently, measurement processing apparatus 100 determines a model formula for each of the three knowledge data sets based on film model 212 included in each knowledge data set (step S28). Subsequently, measurement processing apparatus 100 fits parameters of the model formula in accordance with analysis condition 213 included in each knowledge data set and under the condition that any parameters in the optical constant are allowed to vary so that a spectrum calculated based on the model formula matches the obtained spectrum, thereby calculating a film thickness, a refractive index, and an extinction coefficient for each layer (step S30). Similarly, measurement processing apparatus 100 fits a spectrum calculated based on the model formula to the obtained spectrum in accordance with analysis condition 213 included in each knowledge data set and under the condition that a part of the parameters in the optical constant is allowed to vary, thereby calculating a film thickness, a refractive index, and an extinction coefficient for each layer (step S32).

In steps S30 and S32, the fitting of parameters of the model formula includes varying the film thickness of each layer and at least partially varying the optical constant of each layer.

Furthermore, measurement processing apparatus 100 compares for each of the three knowledge data sets the obtained spectrum with a theoretical spectrum calculated by applying each measurement result to the model formula and calculates one or more indicator values for each measurement result based on a result of the comparison (step S36), and measurement processing apparatus 100 determines a measurement result indicating the best indicator value. That is, measurement processing apparatus 100 determines measurement results each representing a knowledge data set.

In the example shown in FIG. 8, for knowledge data set 3, a measurement result obtained when any parameters in the optical constant are varied is determined as an output. For knowledge data set 5, a measurement result obtained when the optical constant is fixed is determined as an output. For knowledge data set 8, a measurement result obtained when some parameters in the optical constant are varied is determined as an output.

Measurement processing apparatus 100 compares one or more indicator values of the measurement results representing their respective knowledge data sets with each other to determine the best measurement result (step S42).

### E. Outputting Measurement Result

A measurement result such as a film thickness, a refractive index and an extinction coefficient finally determined for each layer may be output to a display of measurement processing apparatus 100 or may be output to a display of any measurement processing terminal. Alternatively, the measurement result may be sequentially stored as electronic data in the storage of measurement processing apparatus 100 or that of the server. For example, data indicating results of sequentially measuring samples may be sequentially stored in the storage of the server.

As will be described hereinafter, when a knowledge data set produced based on a measurement result is added to database 200, not only each layer's film thickness, refractive index and extinction coefficient but also information of a measurement process may be output together. The information of the measurement process includes a film model, an analysis condition, etc.

### Creating and Managing Database 200

Hereinafter, an example of creating and managing database 200 of optical measurement system 1 according to the present embodiment will be described.

A knowledge data set is produced based on a measurement result obtained through a past measurement. One knowledge data set may be produced from a result of measuring one sample. A knowledge data set may be identical to a knowledge data set obtained through a measurement or may be a result of adding some modification to the knowledge data set obtained through the measurement.

Measurement processing apparatus 100 may perform a process of producing a knowledge data set based on a film thickness of each layer of a sample included in a measurement result, and adding the produced knowledge data set to database 200.

A knowledge data set may be based on a result of a simulation. A knowledge data set based on a specific measurement result may be added to measurement knowledge database 210 for example under the condition that the measurement result has a confidence level exceeding a predetermined threshold.

When a sample structure of a sample of a specific measurement result is identical to a sample structure of a knowledge data set already registered in measurement knowledge database 210, the knowledge data set based on the measurement result may be added to database 200 under the condition that the measurement result has a confidence level higher than that of the registered knowledge data set.

While in the above description database 200 includes measurement knowledge database 210 and material information database 220 by way of example, the above-described information may be registered in database 200 in any format. For example, measurement knowledge database 210 may be implemented by a combination of a plurality of tables, or a table in which measurement knowledge database 210 and material information database 220 are integrated may be adopted.

Database 200 may be disposed in at least one of measurement processing apparatus 100 and the server.

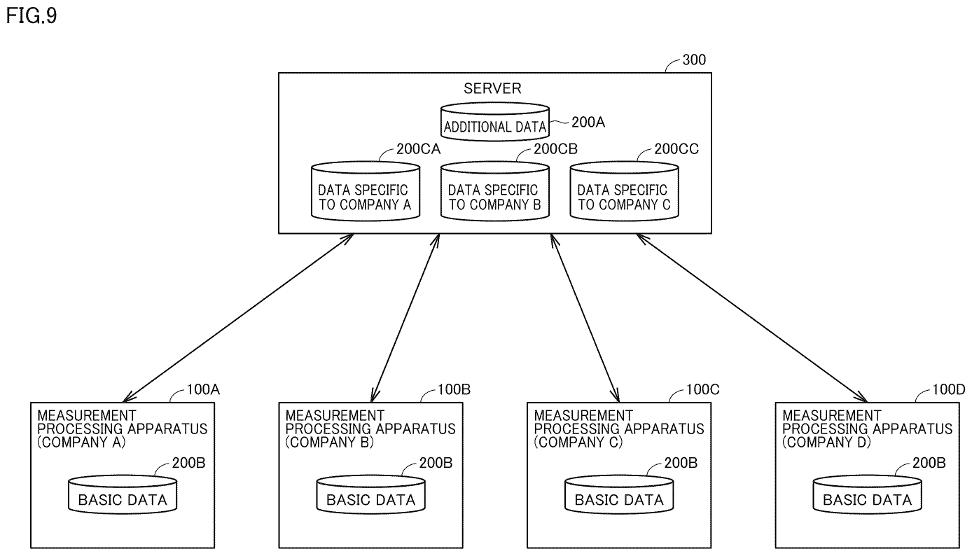

An example of operating measurement processing apparatus 100 according to the present embodiment will be described with reference to FIG. 9. FIG. 9 shows, as an example, optical measurement system 1 introduced in each of companies A to D.

Measurement processing apparatuses 100A to 100D disposed in companies A to D each have a database 200B including basic data. The basic data may for example be a set of knowledge data sets produced based on results of measuring general samples. The basic data may be prepared, for example, by a manufacturer or seller of optical measurement system 1.

A server 300 accessible from measurement processing apparatuses 100A to 100D has a database 200A including additional data. The additional data may for example be a set of knowledge data sets produced based on a result of measuring special samples.

Measurement processing apparatuses 100A to 100D may be capable of accessing database 200A of server 300 when a predetermined condition is satisfied. By accessing database 200A, a first candidate group of knowledge data sets can be extracted from more knowledge data sets.

For example, the predetermined condition may be that a user (e.g., companies A to D) makes a predetermined contract (e.g., to pay a usage fee) with an operator of server 300 (e.g., a manufacturer or seller of optical measurement system 1).

Server 300 may have databases 200CA to 200CC including user-specific data. In the example illustrated in FIG. 9, database 200CA includes data specific to company A, database 200CB includes data specific to company B, and database 200CC includes data specific to company C.

Each user may register a knowledge data set based on a measurement result in database 200CC, as necessary. Alternatively, the manufacturer or seller of optical measurement system 1 may register a knowledge data set in database 200CC based on a measurement result received from each user.

Measurement processing apparatus 100 may have a function of producing a knowledge data set based on a measurement result in response to a user operation or the like, and registering the produced knowledge data set in database 200. As preprocessing for producing a knowledge data set based on a measurement result, measurement processing apparatus 100 may have a filtering function for extracting from one or more measurement results a measurement result to be registered in database 200.

### G. Modification

While in the above description measurement processing apparatus 100 directly obtains a detection result from spectroscopic detector 20 by way of example of configuration, measurement processing apparatus 100 may obtain the detection result output by spectroscopic detector 20 in any manner (for example via a storage medium or a network).

While one example of a measurement process described above (see FIGS. 7 and 8) adopts a process of extracting the first candidate group and that of extracting the second candidate group, they may be partially or entirely simplified.

For example, when measurement knowledge database 210 includes a small number of knowledge data sets, the process of extracting the first candidate group may be dispensed with. That is, steps S6 to S12 may be dispensed with, and steps S14 to S22 may be performed for any knowledge data set included in measurement knowledge database 210.

For example, of measurement results calculated based on knowledge data sets included in the first candidate group (steps S14 to S22), a measurement result with a good indicator value may be determined as a final measurement result. In that case, instead of the process of extracting the second candidate group (step S24), a process of determining the final measurement result is performed based on one or more indicator values. In that case, step S24 et seq. may be dispensed with. Thus, the process of extracting the second candidate group may be dispensed with.

The process of extracting the first candidate group and the process of extracting the second candidate group may both be dispensed with. In that case, a measurement result is calculated based on any knowledge data set included in measurement knowledge database 210. Of such calculated measurement results, a measurement result with a good indicator value may be determined as a final measurement result.

### H. Advantages

According to the present embodiment, an optical measurement system does not require previously determining a model formula corresponding to a sample and instead refers to a database to determine an appropriate sample structure and a model formula corresponding to the sample structure. Therefore, even a user with little expert knowledge or an unskilled user can easily measure the film thickness of each layer of the sample. Furthermore, an indicator can be used to select a sample structure so that accuracy of measurement can be enhanced.

Although the embodiments of the present disclosure have been described, it should be understood that the embodiments disclosed herein are illustrative and non-limiting in any respect. The scope of the present disclosure is defined by the terms of the claims, and is intended to encompass any modification falling within the meaning and scope equivalent to the terms of the claims.

What is claimed is:

1. A measurement processing apparatus configured to perform operations comprising:
obtaining a spectrum of observed light produced from a sample as the sample is irradiated with measurement light;
extracting, as a candidate group, one or more data sets each including a spectrum similar to the spectrum of the observed light with reference to a database including one or more data sets each including at least a film model, an analysis condition, and a spectrum;
with regard to each of the one or more data sets in the candidate group, fitting parameters of a model formula determined based on the film model in the data set in accordance with the analysis condition in the data set so that a spectrum calculated based on the model formula matches the spectrum of the observed light, thereby calculating a measurement result including a film thickness of each layer of the sample; and
determining a film thickness of each layer of the sample based on one or more of measurement results calculated for the data sets in the candidate group.

2. The measurement processing apparatus according to claim 1, wherein
the operations further comprise calculating one or more indicator values based on a result of comparing the spectrum of the observed light with a theoretical spectrum calculated by applying the measurement result to the model formula, and
the film thickness of each layer of the sample is determined based on one or more indicator values for each measurement result.

3. The measurement processing apparatus according to claim 1, wherein fitting parameters of the model formula includes varying a film thickness of each layer and at least partially varying an optical constant of each layer.

4. The measurement processing apparatus according to claim 3, wherein
a first measurement result is calculated by fitting parameters of the model formula under a condition that a film thickness of each layer is allowed to vary while an optical constant of each layer is fixed, and
a second measurement result is calculated by fitting parameters of the model formula under a condition that a film thickness of each layer is allowed to vary at least partially and an optical constant of each layer is allowed to vary at least partially, using the first measurement result as a reference, and
the operations further comprise discarding the second measurement result when a variation in the second measurement result exceeds a predetermined threshold.

5. The measurement processing apparatus according to claim 1, wherein at least a part of the database is located in a server separate from the measurement processing apparatus.

6. The measurement processing apparatus according to claim 1, wherein the operations further comprise producing a data set based on the determined film thickness of each layer of the sample and adding the data set to the database.

7. The measurement processing apparatus according to claim 1, wherein the film model in the data set includes a default value of an optical constant of each layer.

8. The measurement processing apparatus according to claim 1, wherein the analysis condition includes specifying an analysis method for fitting parameters of the model formula.

9. A measurement method comprising:
obtaining a spectrum of observed light produced from a sample as the sample is irradiated with measurement light;
extracting, as a candidate group, one or more data sets each including a spectrum similar to the spectrum of the observed light with reference to a database including one or more data sets each including at least a film model, an analysis condition, and a spectrum;
with regard to each of the one or more data sets in the candidate group, fitting parameters of a model formula determined based on the film model in the data set in accordance with the analysis condition in the data set so that a spectrum calculated based on the model formula matches the spectrum of the observed light, thereby calculating a measurement result including a film thickness of each layer of the sample; and
determining a film thickness of each layer of the sample based on one or more of measurement results calculated for the data sets in the candidate group.

10. The measurement method according to claim 9, further comprising
calculating one or more indicator values based on a result of comparing the spectrum of the observed light with a theoretical spectrum calculated by applying the measurement result to the model formula, and
wherein the film thickness of each layer of the sample is determined based on one or more indicator values for each measurement result.

11. The measurement method according to claim 9, wherein fitting parameters of the model formula includes varying a film thickness of each layer and at least partially varying an optical constant of each layer.

12. The measurement method according to claim 11, wherein
a first measurement result is calculated by fitting parameters of the model formula under a condition that a film thickness of each layer is allowed to vary while an optical constant of each layer is fixed, and
a second measurement result is calculated by fitting parameters of the model formula under a condition that a film thickness of each layer is allowed to vary at least partially and an optical constant of each layer is allowed to vary at least partially, using the first measurement result as a reference, and
the measurement method further comprises discarding the second measurement result when a variation in the second measurement result exceeds a predetermined threshold.

13. The measurement method according to claim 9, further comprising
producing a data set based on the determined film thickness of each layer of the sample and adding the data set to the database.

14. The measurement method according to claim 9, wherein the film model in the data set includes a default value of an optical constant of each layer.

15. A non-transitory computer-readable storage medium storing instructions that, when executed by one or more processors, cause the one or more processors to perform the operations comprising:
obtaining a spectrum of observed light produced from a sample as the sample is irradiated with measurement light;
extracting, as a candidate group, one or more data sets each including a spectrum similar to the spectrum of the observed light with reference to a database including one or more data sets each including at least a film model, an analysis condition, and a spectrum;
with regard to each of the one or more data sets in the candidate group, fitting parameters of a model formula determined based on the film model in the data set in accordance with the analysis condition in the data set so that a spectrum calculated based on the model formula matches the spectrum of the observed light, thereby calculating a measurement result including a film thickness of each layer of the sample; and
determining a film thickness of each layer of the sample based on one or more of measurement results calculated for the data sets in the candidate group.

16. The non-transitory computer-readable storage medium according to claim 15, wherein
the operations further comprise calculating one or more indicator values based on a result of comparing the spectrum of the observed light with a theoretical spectrum calculated by applying the measurement result to the model formula, and
the film thickness of each layer of the sample is determined based on one or more indicator values for each measurement result.

17. The non-transitory computer-readable storage medium according to claim 15, wherein fitting parameters of the model formula includes varying a film thickness of each layer and at least partially varying an optical constant of each layer.

18. The non-transitory computer-readable storage medium according to claim 17, wherein
a first measurement result is calculated by fitting parameters of the model formula under a condition that a film thickness of each layer is allowed to vary while an optical constant of each layer is fixed, and
a second measurement result is calculated by fitting parameters of the model formula under a condition that a film thickness of each layer is allowed to vary at least partially and an optical constant of each layer is allowed to vary at least partially, using the first measurement result as a reference, and
the operations further comprise discarding the second measurement result when a variation in the second measurement result exceeds a predetermined threshold.

19. The non-transitory computer-readable storage medium according to claim 15, wherein the operations further comprise producing a data set based on the determined film thickness of each layer of the sample and adding the data set to the database.

20. The non-transitory computer-readable storage medium according to claim 15, wherein the film model in the data set includes a default value of an optical constant of each layer.
